(19) United States
(12) Patent Application Publication
(10) Pub. No.: US 2007/0081765 A1
(43) Pub. Date: Apr. 12, 2007

(54) Package structure of a wavelength division multiplexing device

(76) Inventor: Ching-Shiang Wang, Tanzih Township (TW)

Correspondence Address: LOWE HAUPTMAN BERNER, LLP, 1700 DIAGONAL ROAD, SUITE 300, ALEXANDRIA, VA, 22314, US

(21) Appl. No.: 11/503,201

(22) Filed: Aug. 14, 2006

(30) Foreign Application Priority Data
Sep. 26, 2005 (TW) 094133369

(51) Int. Cl. G02B 6/32

(52) U.S. Cl. 385/34

(57) ABSTRACT

A package structure of a WDM device is disclosed. The package structure disclosed here can effectively reduce the amount of the adhesive leaking during the manufacturing process and increase the yield of the manufacturing process. The package includes: a tubular fixing unit having a low thermal expansion coefficient; a first collimator partially embedded in the tubular fixing unit; a second collimator partially embedded in the tubular fixing unit and a filter located between the first and second collimators inside the tubular fixing unit. The first and second collimators are fixed to the tubular fixing unit through an adhesive, respectively. Besides, an external metal tube encompasses the tubular fixing unit. In cooperation with the two metal caps positioned at the two ends of the external metal tube, the disclosed package structure can be protected from the damage otherwise caused by heat, electromagnetic waves or vibration of the ambient environment.

### BACKGROUND OF THE INVENTION

1. Field of the Invention

The present invention relates to the package structure of a wavelength division multiplexing [WDM] device and, more particularly, to a package structure of a WDM device which can effectively reduce the amount of adhesive leaking during the manufacturing process and increase the yield of the manufacturing process of the WDM device.

2. Description of Related Art

Referring to FIG. 1, which is a sectional view of the conventional package structure of a WDM device. The package structure of the WDM device 1 comprises: a metal shell 11, an insulating protective layer 12, a first GRIN lens 13, a second GRIN lens 14 and an IR-cut lens 15 wherein the first GRIN lens 13, the second GRIN lens 14 and the IR-cut lens 15 are fixed to the insulating protective layer 12 through UV adhesives 131, 141 151, respectively. The metal shell 11 encompasses the outer surface of the insulating protective layer 12 and protects the elements of the package structure of the WDM device inside it. Besides, the terminal of the first GRIN lens 13 is connected with a fiber pigtail 132 and the terminal of the second GRIN lens 14 is connected with another fiber pigtail 142.

As clearly shown in FIG. 1, the relative positions of the first GRIN lens 13, the second GRIN lens 14 and the IR-cut lens 15 are determined by the thicknesses of the UV adhesive 131, 141, 151. As a result, during the manufacturing process of the package structure of the WDM device, these elements must be installed carefully and the thickness of all the UV adhesives must be precisely controlled. Therefore, these elements must be fixed to the insulating protective layer 12 separately and this operation is particularly time-consuming. Besides, since the outer radii of these elements (the first GRIN lens 13, the second GRIN lens 14 and the IR-cut lens 15) are much smaller than the inner radius of the insulating protective layer 12, these elements cannot be fixed to the insulating protective layer 12 by the embedding method.

Hence, as shown in FIG. 1, since these UV adhesives 131,141,151 fixing these elements all have certain thickness, there are some disadvantages for having such thick VW adhesives, which are as follows:
(a) Since the UV adhesive is extremely expensive it costs a lot to form these thick UV adhesives to fix the elements;
(b) Since the UV adhesive is formed through the transformation from the original liquid-state precursor into the solid-state adhesive when it is exposed to a UV light, if the UV adhesive is too thick, it is likely that only the liquid-state precursor near the surface of a drop is transformed into solid-state adhesive. This means the liquid-state precursor near the center region of the drop still remains in its original liquid-state. Therefore, even with certain exposure to the UV light, the whole drop is likely to remain in a composition of a liquid-state precursor and solid-state adhesive and flows only gradually. As a result, the relative position relation of the elements (the first GRIN lens 13, the second GRIN lens 14 and the IR-cut lens 15) cannot be efficiently maintained; and
(c) As described in (b), since the drop is still flowing slowly, the UV adhesive is likely to flow onto the optical surfaces of these elements. Therefore, the UV adhesives contaminate the optical surfaces of these elements and make the optical efficiency of these elements deteriorate.

In summary, since the manufacturing process of the conventional package structure of the WDM device has the following disadvantages: (a) its working steps are complex; (b) it cannot precisely define the positions of the elements; (c) it involves a large amount of expensive UV adhesive during the whole process; and (d) the UV adhesive flows onto and damages the optical surfaces of the elements easily. As a result, it is desirable to provide an improved package of a WDM device to mitigate and/or obviate the aforementioned problems.

### SUMMARY OF THE INVENTION

The package structure for a wavelength division multiplexing device of the present invention comprises: a tubular fixing unit having a low thermal expansion coefficient; a first collimator partially embedded in the tubular fixing unit; a second collimator partially embedded in the tubular fixing unit; and a filter mounted inside the tubular fixing unit and located between the first collimator and the second collimator. Wherein the first collimator and the second collimator are fixed to the tubular fixing unit through an adhesive, respectively.

Another package structure for a wavelength division multiplexing device of the present invention comprises: a tubular fixing unit having a low thermal expansion coefficient; a first collimator partially embedded in the tubular fixing unit, where an IR-cut coating is formed on the surface of the first collimator inside the tubular fixing unit; and a second collimator partially embedded in the tubular fixing unit. Wherein the first collimator and the second collimator are fixed to the tubular fixing unit through an adhesive, respectively.

Therefore, by having the package structure of the present invention, the amount of the adhesive leaking during the manufacturing process of a WDM device can be reduced and the yield of the manufacturing process can also be increased. In addition, since the relative position of each optical element (e.g. the first GRIN lens, infrared cut lens and the second GRIN lens) are determined and maintained by the tubular fixing unit (a glass tube or a metal tube), the optical path (e.g. the collimation) is easily maintained once all the optical elements are assembled in their predetermined positions. The labor for carefully aligning all the optical elements involved can also be saved. Besides, the manufacturing process of the WDM device of the present invention can be greatly simplified and the manufacturing amount of the WDM device having the package structure of the present embodiment can be dramatically increased compared to that of the WDM device having the conventional package structure.

The type of the first collimator in the package structure of the WDM device of the present invention is not limited; preferably the first collimator is a GRIN lens. The type of the second collimator in the package structure of the WDM device of the present invention is not limited; preferably the second collimator is a GRIN lens. The type of the adhesive fixing the first collimator to the tubular fixing unit in the package structure of the WDM device of the present invention is not limited, preferably the first collimator is fixed to the tubular fixing unit through a UV cure adhesive or a thermal cure adhesive. The type of the adhesive fixing the second collimator to the tubular fixing unit in the package structure of the WDM device of the present invention is not limited; preferably the second collimator is fixed to the tubular fixing unit through a UV cure adhesive or a thermal cure adhesive. The material of the tubular fixing unit of the package structure of the WDM device of the present invention is not limited; preferably the tubular fixing unit is made of glass, metal or ceramic.

Other objects, advantages, and novel features of the invention will become more apparent from the following detailed description when taken in conjunction with the accompanying drawings.

### BRIEF DESCRIPTION OF THE DRAWINGS

FIG. 1 is a sectional view of the conventional package structure of a WDM device.

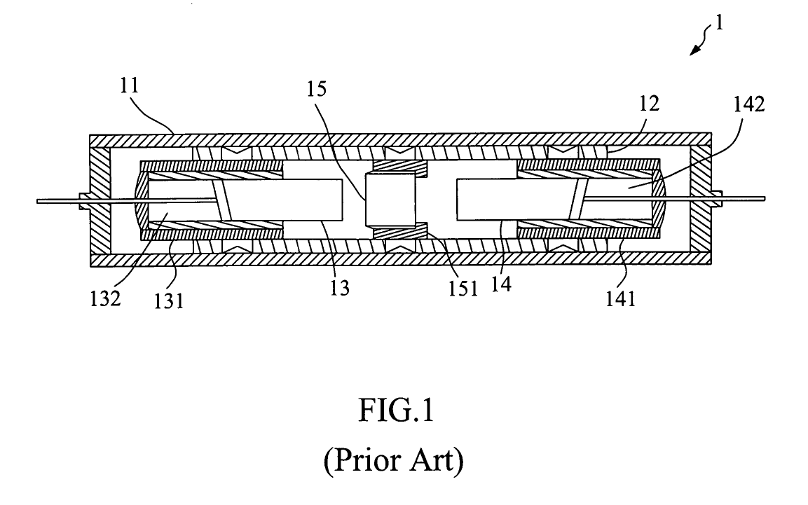

FIG. 2A is a perspective view of the package structure of a WDM device according to the first preferred embodiment of the present invention.

FIG. 2B is a sectional view of the package structure of a WDM device according to the first preferred embodiment of the present invention.

FIG. 3A is a perspective view of the package structure of a WDM device according to the second preferred embodiment of the present invention.

FIG. 3B is a sectional view of the package structure of a WDM device according to the second preferred embodiment of the present invention.

FIG. 4A is a perspective view of the package structure of a WDM device according to the third preferred embodiment of the present invention.

FIG. 4B is a sectional view of the package structure of a WDM device according to the third preferred embodiment of the present invention.

FIG. 5A is a perspective view of the package structure of a WDM device according to the fourth preferred embodiment of the present invention.

FIG. 5B is a sectional view of the package structure of a WDM device according to the fourth preferred embodiment of the present invention.

### DETAILED DESCRIPTION OF THE PREFERRED EMBODIMENT

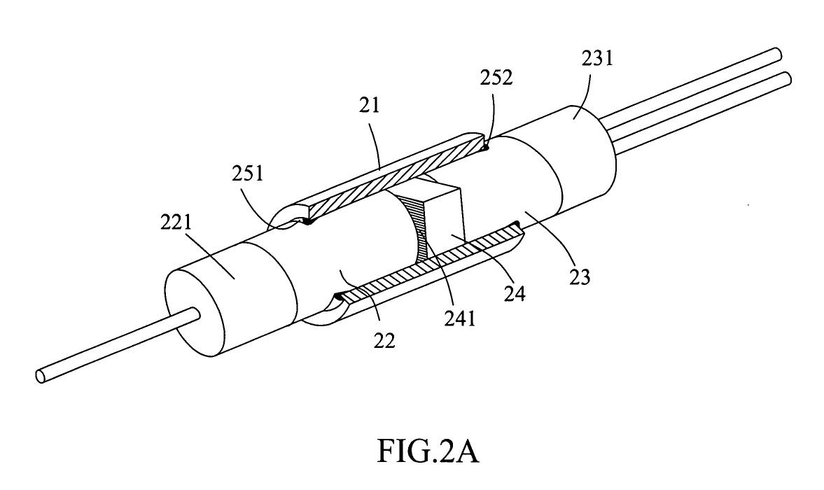

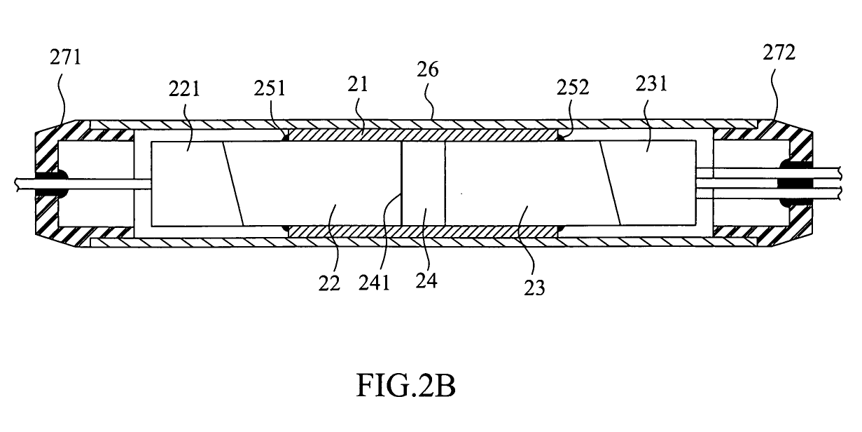

With reference to FIG. 2A, there is shown the first preferred embodiment of a package structure of a wavelength division multiplexing device (WDM) of the present invention. The package structure for a WDM of the present embodiment includes a glass tube 21, a first GRIN lens 22, a second GRIN lens 23, and a cube-shaped IR-cut lens 24. As shown in FIG. 2A, part of the first GRIN lens 22 and part of the second GRIN lens 23 are embedded in the glass tube 21. The glass tube 21 is made of glass the thermal expansion coefficient of which is very low. In the present embodiment, the diameter of the inner wall of the glass tube 21 is about 1.8 mm, while the diameters of the outer surface of the first GRIN lens 22 and the second GRIN lens 23 are both about 1.79 mm. That is, the diameters of the outer surface of these two GRIN lens 22,23 are close in size to the diameter of the inner wall of the glass tube 21. Besides, the terminal of the first GRIN lens 22 outside the glass tube 21 is connected with a single fiber pigtail 221. Likewise, the terminal of the second GRIN lens 23 outside the glass tube 21 is connected with a dual fiber pigtail 231.

In the gap between the outer surface of the first GRIN lens 22 and the inner wall of the glass tube 21, a UV cure adhesive 251 is injected for fixing the embedded part of the first GRIN lens 22 to the glass tube 21 securely. Similarly, in the gap between the outer surface of the second GRIN lens 23 and the inner wall of the glass tube 21, another UV cure adhesive 252 is injected for fixing the embedded part of the second GRIN lens 23 and the glass tube 21.

The package structure of the first preferred embodiment of the present invention is manufactured through the following process.

First, the glass tube 21, the first GRIN lens 22, the second GRIN lens 23 and the cube-shaped infrared cut lens 24 are provided. The first GRIN lens 22 is embedded into the glass tube 21 partially. As described above, since the diameter of the outer surface of the first GRIN lens 22 (about 1.79 mm) is a little smaller than the diameter of the inner wall of the glass tube 21(about 1.8 mm), a small gap is formed between the outer surface of the first GRIN lens 22 and the inner wall of the glass tube 21. Subsequently, after a small amount of liquid-state precursor of a UV cure adhesive is injected at the seam between the small gap and the ambient outer space, the liquid-state precursor flows into the small gap slowly and stops flowing when the small gap is filled with the liquid-state precursor as a result of the “siphon effect”. Then, the liquid-state precursor filling the small gap is exposed to a UV radiation (UV curing process). As a result, the liquid-state precursor is transformed into the solid-state adhesive (UV cure adhesive) inside the small gap. In addition, a UV gun or a UV oven can provide the UV radiation to the liquid-state precursor in the present embodiment.

After the first GRIN lens is securely fixed to the glass tube 21, the cube-shaped infrared cut lens 24 is squeezed into the glass tube 21 through the opening on the other side of the glass tube 21. The cube-shaped infrared cut lens 24 with a surface 241 having an IR-cut coating is squeezed into the glass tube 21 until being stopped by the first GRIN lens 22. Since the diagonal dimension (about 1.77 mm) of the cube-shaped infrared cut lens 24 of the present embodiment is a little smaller than the diameter of the inner wall of the glass tube 21 (about 1.8 mm), the cube-shaped infrared cut lens 24 can be fixed inside the glass tube 21 easily without using any adhesive (e.g. a UV cure adhesive or a thermal cure adhesive).

After the cube-shaped infrared cut lens 24 is fixed inside the glass tube 21, the second GRIN lens 23 is then squeezed into the glass tube 21 through the same opening through which the cube-shaped infrared cut lens 24 has been squeezed. The second GRIN lens 23 is squeezed into the glass tube 21 until being stopped by the cube-shaped infrared cut lens 24.

Similarly, there is also a small gap located between the outer surface of the second GRIN lens 23 and the inner wall of the glass tube 21. A small amount of liquid-state precursor of a UV cure adhesive is injected at the seam between the small gap and the ambient outer space. Again, due to the “siphon effect”, the liquid-state precursor flows into the small gap slowly and stops flowing when the small gap is filled with the liquid-state precursor. Then the liquid-state precursor filling the small gap is exposed to a UV radiation (UV curing process). As a result, the liquid-state precursor is transformed into the solid-state adhesive (UV cure adhesive) inside the small gap.

Furthermore, the terminal of the first GRIN lens 22 outside the glass tube 21 is connected with a single fiber pigtail 221 through a thermal cure adhesive or a UV cure adhesive. Similarly, the terminal of the second GRIN lens 23 outside the glass tube 21 is connected with a dual fiber pigtail 231 through a thermal cure adhesive or a UV cure adhesive. The resulting package structure of a WDM device of the present invention according to the present embodiment is as shown in FIG. 2A.

As shown in FIG. 2B, the package structure of a WDM device is then inserted into an external metal tube 26 and the two terminals of the external metal tube 26 are respectively covered with the external metal caps 271, 272 for protecting the WDM device. (e.g. protecting the WDM device from heat, electromagnetic interference, or impact).

Therefore, by having the package structure of the present invention illustrated above, the amount of the adhesive leaking during the manufacturing process of the WDM device can be reduced and the yield of the manufacturing process can also be increased. In addition, since the relative position of each optical element (e.g. the first GRIN lens, the IR-cut lens, and the second GRIN lens) are determined and maintained by the glass tube, the optical path (e.g. the collimation) is easily maintained once all the optical elements are assembled in their predetermined positions. Hence, by using the package structure of the WDM device of the present invention, the labor for carefully aligning all the optical elements involved can be saved, the manufacturing process of the WDM device of the present invention can be greatly simplified and the yield of the manufacturing process can also be effectively improved.

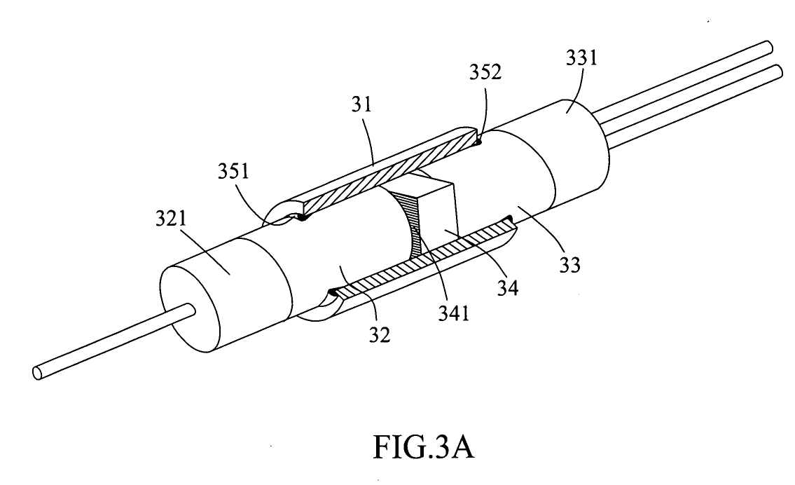

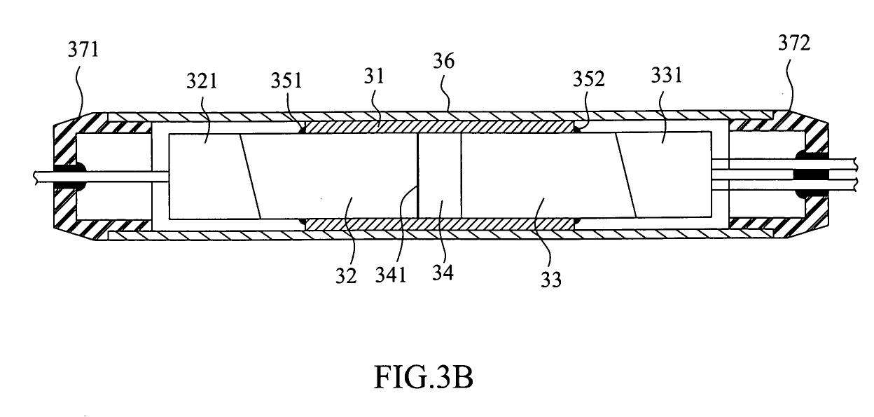

With reference to FIG. 3A, there is shown the second preferred embodiment of a package structure of a WDM device of the present invention. The package structure for a WDM of the present embodiment includes a metal tube 31, a first GRIN lens 32, a second GRIN lens 33, and a cube-shaped IR-cut lens 24. As shown in FIG. 3A, part of the first GRIN lens 32 and part of the second GRIN lens 33 are embedded in the metal tube 31. The metal tube 31 is made of metal the thermal expansion coefficient of which is low. In the present embodiment, the diameter of the inner wall of the metal tube 31 is about 1.8 mm, while the diameters of the outer surface of the first GRIN lens 32 and the second GRIN lens 33 are both about 1.79 mm. That is, the diameters of the outer surface of these two GRIN lens 32,33 are close in size to the diameter of the inner wall of the metal tube 31. Besides, the terminal of the first GRIN lens 32 outside the metal tube 31 is connected with a single fiber pigtail 321. Likewise, the terminal of the second GRIN lens 33 outside the metal tube 31 is connected with a dual fiber pigtail 331.

In the gap between the outer surface of the first GRIN lens 32 and the inner wall of the metal tube 31, a thermal cure adhesive 351 is injected for fixing the embedded part of the first GRIN lens 32 to the metal tube 31 securely. Similarly, in the gap between the outer surface of the second GRIN lens 33 and the inner wall of the metal tube 31, another thermal cure adhesive 352 is injected for fixing the embedded part of the second GRIN lens 33 and the metal tube 31.

The package structure of the second preferred embodiment of the present invention is manufactured through the following process.

First, the metal tube 31, the first GRIN lens 32, the second GRIN lens 33 and the cube-shaped infrared cut lens 34 are provided. The first GRIN lens 32 is embedded into the metal tube 31 partially. As described above, since the diameter of the outer surface of the first GRIN lens 32 (about 1.79 mm) is a little smaller than the diameter of the inner wall of the metal tube 31(about 1.8 mm), a small gap is formed between the outer surface of the first GRIN lens 32 and the inner wall of the metal tube 31. Subsequently, after a small amount of liquid-state precursor of a thermal cure adhesive is injected at the seam between the small gap and the ambient outer space, the liquid-state precursor flows into the small gap slowly and then stops flowing when the small gap is filled with the liquid-state precursor as a result of the “siphon effect”. Then, the liquid-state precursor filling in the small gap is heated (thermal curing process). As a result, the liquid-state precursor inside the small gap is transformed into the solid-state thermal cure adhesive 351. In the present embodiment, an oven can provide the heat required in the thermal curing process.

After the first GRIN lens 32 is securely fixed to the metal tube 31, the cube-shaped infrared cut lens 34 is squeezed into the metal tube 31 through the opening on the other side of the metal tube 31. The cube-shaped infrared cut lens 34, the surface 341 of which having an IR-cut coating, is squeezed into the metal tube 31 until being stopped by the first GRIN lens 32. Since the diagonal dimension (about 1.77 mm) of the cube-shaped infrared cut lens 34 of the present embodiment is a little smaller than the diameter of the inner wall of the metal tube 31 (about 1.8 mm), the cube-shaped infrared cut lens 34 can be fixed inside the metal tube 31 easily without using any adhesive (e.g. a UV cure adhesive or a thermal cure adhesive).

After the cube-shaped infrared cut lens 34 is fixed inside the metal tube 31, the second GRIN lens 33 is then squeezed into the metal tube 31 through the same opening through which the cube-shaped infrared cut lens 34 has been squeezed. The second GRIN lens 33 is squeezed into the metal tube 31 until being stopped by the infrared cut lens 34.

Similarly, there is also a small gap located between the outer surface of the second GRIN lens 33 and the inner wall of the metal tube 31. A small amount of liquid-state precursor of a thermal cure adhesive is injected at the seam between the small gap and the ambient outer space. Again, due to the “siphon effect”, the liquid-state precursor flows into the small gap slowly and stops flowing when the small gap is filled with the liquid-state precursor. Then the liquid-state precursor filling the small gap is heated (thermal curing process). As a result, the liquid-state precursor inside the small gap is transformed into the solid-state thermal cure adhesive 352 inside the small gap. In the present embodiment, an oven can provide the heat required in the thermal curing process.

Furthermore, the terminal of the first GRIN lens 32 outside the metal tube 31 is connected with a single fiber pigtail 321 through a thermal cure adhesive or a UV cure adhesive. Similarly, the terminal of the second GRIN lens 33 outside the metal tube 31 is connected with a dual fiber pigtail 331 through a thermal cure adhesive or a UV cure adhesive. The resulting package structure of a WDM device of the present invention according to the present embodiment is as shown in FIG. 3A.

As shown in FIG. 3B, the package structure of a WDM device is then inserted into an external metal tube 36 and the two terminals of the external metal tube 36 are respectively covered with the external metal caps 371, 372 for protecting the WDM device. (e.g. protecting the WDM device from heat, electromagnetic interference, or impact).

Therefore, by having the package structure of the present invention illustrated above, the amount of the adhesive leaking during the manufacturing process of the WDM device can be reduced and the yield of the manufacturing process can also be increased. In addition, since the relative position of each optical element (e.g. the first GRIN lens, the IR-cut lens, and the second GRIN lens) are determined and maintained by the metal tube; the optical path (e.g. the collimation) is easily maintained once all the optical elements are assembled in their predetermined positions.

Moreover, since hundreds, even thousands of the metal tubes each having the liquid-state precursor of the thermal cure adhesive in their small gaps can be heated in an oven at the same time, the manufacturing amount of the WDM device having the package structure of the present embodiment can be dramatically increased compared to that of the WDM device having the conventional package structure.

Hence, by using the package structure of the WDM device of the present invention, the labor for carefully aligning all the optical elements involved can be saved, the manufacturing process of the WDM device of the present invention can be greatly simplified and the yield of the manufacturing process can also be effectively improved.

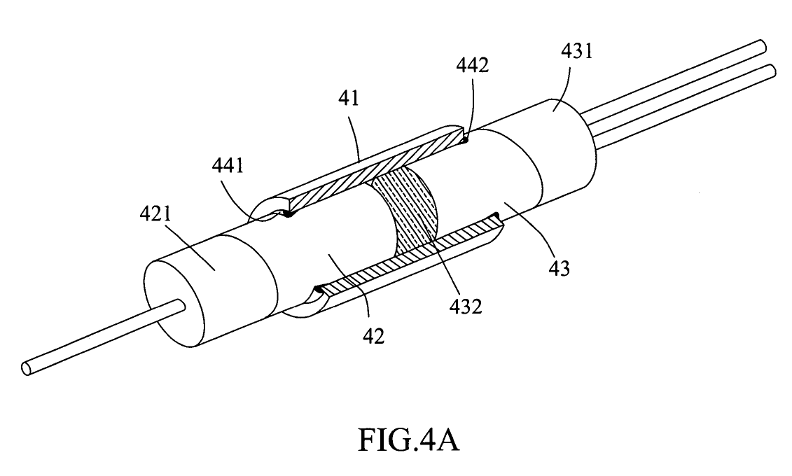

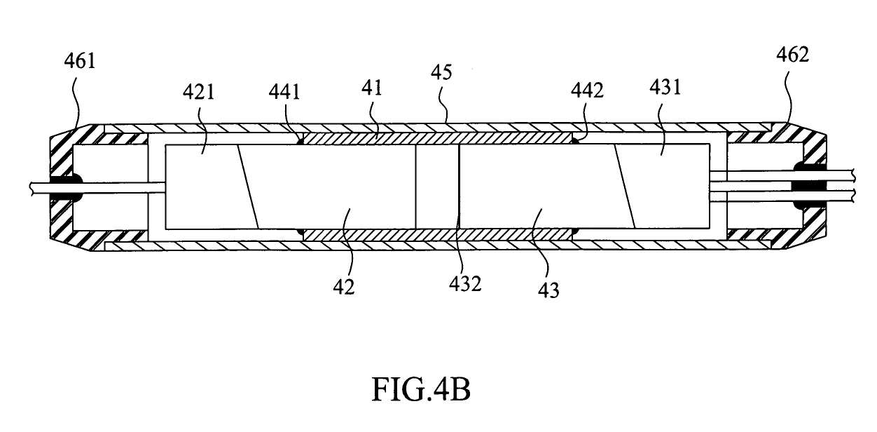

With reference to FIG. 4A, there is shown the third preferred embodiment of a package structure of a WDM device of the present invention. The package structure for a WDM of the present embodiment includes a glass tube 41, a first GRIN lens 42 and a second GRIN lens 43 wherein an IR-cut coating is formed on the surface 432 of the second GRIN lens 43. As shown in FIG. 4A, part of the first GRIN lens 42 and part of the second GRIN lens 43 are embedded in the glass tube 41. The glass tube 41 is made of glass the thermal expansion coefficient of which is very low. In the present embodiment, the diameter of the inner wall of the glass tube 41 is about 1.8 mm, while the diameters of the outer surface of the first GRIN lens 42 and the second GRIN lens 43 are both about 1.79 mm. That is, the diameters of the outer surface of these two GRIN lenses 42,43 are close in size to the diameter of the inner wall of the glass tube 41. Besides, the terminal of the first GRIN lens 42 outside the glass tube 41 is connected with a single fiber pigtail 421. Likewise, the terminal of the second GRIN lens 43 outside the glass tube 41 is connected with a dual fiber pigtail 431.

In the gap between the outer surface of the first GRIN lens 42 and the inner wall of the glass tube 41, a UV cure adhesive 441 is injected for fixing the embedded part of the first GRIN lens 42 to the glass tube 41 securely. Similarly, in the gap between the outer surface of the second GRIN lens 43 and the inner wall of the glass tube 41, another UV cure adhesive 442 is injected for fixing the embedded part of the second GRIN lens 43 and the glass tube 41.

The package structure of the third preferred embodiment of the present invention is manufactured through the following process.

First, the glass tube 41, the first GRIN lens 42 and the second GRIN lens 43 the surface 432 of which has an IR-cut coating are provided. The first GRIN lens 42 is embedded into the glass tube 41 partially. As described above, since the diameter of the outer surface of the first GRIN lens 42 (about 1.79 mm) is a little smaller than the diameter of the inner wall of the glass tube 41(about 1.8 mm), a small gap is formed between the outer surface of the first GRIN lens 42 and the inner wall of the glass tube 41. Subsequently, after a small amount of liquid-state precursor of a UV cure adhesive is injected at the seam between the small gap and the ambient outer space, the liquid-state precursor flows into the small gap slowly and stops flowing when the small gap is filled with the liquid-state precursor as a result of the “siphon effect”. Then the liquid-state precursor filling the small gap is exposed to a UV radiation (UV curing process). As a result, the liquid-state precursor is transformed into the solid-state adhesive (UV cure adhesive) inside the small gap. In addition, a UV gun or a UV oven can provide the UV radiation to the liquid-state precursor in the present embodiment.

After the first GRIN lens 42 has been fixed to the glass tube 41, the second GRIN lens 43 is then squeezed into the glass tube 41 through the opening on the other side of the glass tube 41. Similarly, there is also a small gap located between the outer surface of the second GRIN lens 43 and the inner wall of the glass tube 41. A small amount of liquid-state precursor of a UV cure adhesive is injected at the seam between the small gap and the ambient outer space. Again, due to the “siphon effect”, the liquid-state precursor flows into the small gap slowly and stops flowing when the small gap is filled with the liquid-state precursor. Then the liquid-state precursor filling the small gap is exposed to a UV radiation (UV curing process). As a result, the liquid-state precursor is transformed into the solid-state adhesive (UV cure adhesive) inside the small gap.

Furthermore, the terminal of the first GRIN lens 42 outside the glass tube 41 is connected with a single fiber pigtail 421 through a thermal cure adhesive or a UV cure adhesive. Similarly, the terminal of the second GRIN lens 43 outside the glass tube 41 is connected with a dual fiber pigtail 431 through a thermal cure adhesive or a UV cure adhesive. The resulting package structure of a WDM device of the present invention according to the present embodiment is as shown in FIG. 4A.

As shown in FIG. 4B, the package structure of a WDM device is then inserted into an external metal tube 45 and the two terminals of the external metal tube 45 are respectively covered with the external metal caps 461, 462 for protecting the WDM device. (e.g. protecting the WDM device from heat, electromagnetic interference, or impact).

Therefore, by having the package structure of the present invention illustrated above, the amount of the adhesive leaking during the manufacturing process of the WDM device can be reduced and the yield of the manufacturing process can also be increased. In addition, since the relative position of each optical element (e.g. the first GRIN lens and the second GRIN lens) are determined and maintained by the glass tube, the optical path (e.g. the collimation) is easily maintained once all the optical elements are assembled in their predetermined positions. Hence, by using the package structure of the WDM device of the present invention, the labor for carefully aligning all the optical elements involved can be saved, the manufacturing process of the WDM device of the present invention can be greatly simplified and the yield of the manufacturing process can also be effectively improved.

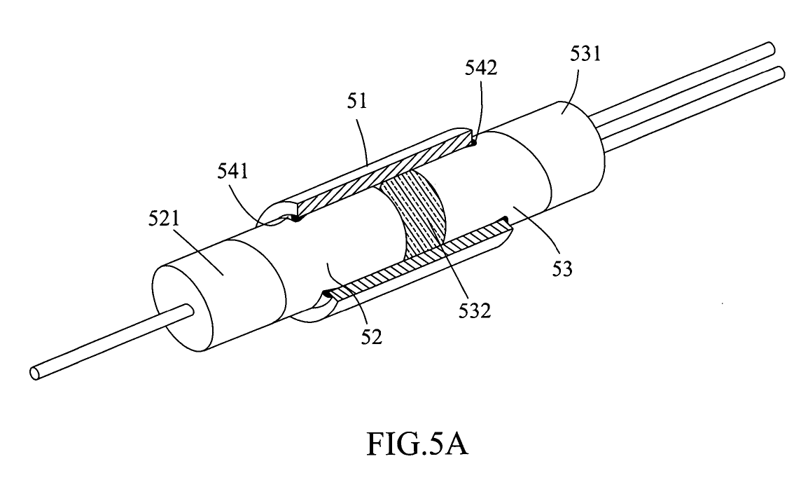

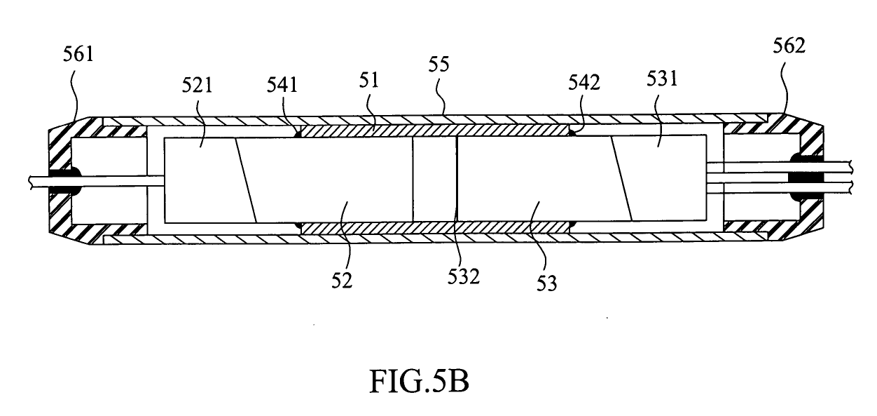

With reference to FIG. 5A, there is shown the fourth preferred embodiment of a package structure of a WDM device of the present invention. The package structure for a WDM of the present embodiment includes a metal tube 51, a first GRIN lens 52 and a second GRIN lens 53 wherein an IR-cut coating is formed on the surface 532 of the second GRIN lens 53. As shown in FIG. 5A, part of the first GRIN lens 52 and part of the second GRIN lens 53 are embedded in the metal tube 51. The metal tube 51 is made of metal the thermal expansion coefficient of which is low. In the present embodiment, the diameter of the inner wall of the metal tube 51 is about 1.8 mm, while the diameters of the outer surface of the first GRIN lens 52 and the second GRIN lens 53 are both about 1.79 mm. That is, the diameters of the outer surface of these two GRIN lens 52,53 are close in size to the diameter of the inner wall of the metal tube 51. Besides, the terminal of the first GRIN lens 52 outside the metal tube 51 is connected with a single fiber pigtail 521. Likewise, the terminal of the second GRIN lens 53 outside the metal tube 51 is connected with a dual fiber pigtail 531.

In the gap between the outer surface of the first GRIN lens 52 and the inner wall of the metal tube 51, a thermal cure adhesive 541 is injected for fixing the embedded part of the first GRIN lens 52 to the metal tube 51 securely. Similarly, in the gap between the outer surface of the second GRIN lens 53 and the inner wall of the metal tube 51, another thermal cure adhesive 542 is injected for fixing the embedded part of the second GRIN lens 53 and the metal tube 51.

The package structure of the fourth preferred embodiment of the present invention is manufactured through the following process.

First, the metal tube 51, the first GRIN lens 52 and the second GRIN lens 53 the surface 532 of which has an IR-cut coating are provided. The first GRIN lens 52 is embedded into the metal tube 51 partially. As described above, since the diameter of the outer surface of the first GRIN lens 52 (about 1.79 mm) is a little smaller than the diameter of the inner wall of the metal tube 51 (about 1.8 mm), a small gap is formed between the outer surface of the first GRIN lens 52 and the inner wall of the metal tube 51. Subsequently, after a small amount of liquid-state precursor of a thermal cure adhesive is injected at the seam between the small gap and the ambient outer space. The liquid-state precursor flows into the small gap slowly and stops flowing when the small gap is filled with the liquid-state precursor as a result of the “siphon effect”. Then the liquid-state precursor filling the small gap is heated (thermal curing process). As a result, the liquid-state precursor inside the small gap is transformed into the solid-state thermal cure adhesive 541. In the present embodiment, an oven can provide the heat required in the thermal curing process.

After the first GRIN lens 52 is securely fixed to the metal tube 51, the second GRIN lens 53 is then squeezed into the metal tube 51 through the opening on the other side of the glass tube 51. Similarly, there is also a small gap located between the outer surface of the second GRIN lens 53 and the inner wall of the metal tube 51. A small amount of liquid-state precursor of a thermal cure adhesive is injected at the seam between the small gap and the ambient outer space. Again, due to the “siphon effect”, the liquid-state precursor flows into the small gap slowly and stops flowing when the small gap is filled with the liquid-state precursor. Then the liquid-state precursor filling in the small gap is heated (thermal curing process). As a result, the liquid-state precursor inside the small gap is transformed into the solid-state thermal cure adhesive 542 inside the small gap. In the present embodiment, an oven can provide the heat required in the thermal curing process.

Furthermore, the terminal of the first GRIN lens 52 outside the metal tube 51 is connected with a single fiber pigtail 521 through a thermal cure adhesive or a UV cure adhesive. Similarly, the terminal of the second GRIN lens 53 outside the metal tube 51 is connected with a dual fiber pigtail 531 through a thermal cure adhesive or a UV cure adhesive. The resulting package structure of a WDM device of the present invention according to the present embodiment is as shown in FIG 5A.

As shown in FIG. 5B, the package structure of a WDM device is then inserted into an external metal tube 55 and the two terminals of the external metal tube 55 are respectively covered with the external metal caps 561, 562 for protecting the WDM device. (e.g. protecting the WDM device from heat, electromagnetic interference, or impact).

Therefore, by having the package structure of the present invention illustrated above, the amount of the adhesive leaking during the manufacturing process of the WDM device can be reduced and the yield of the manufacturing process can also be increased. In addition, since the relative position of each optical element (e.g. the first GRIN lens and the second GRIN lens) are determined and maintained by the metal tube, the optical path (e.g. the collimation) is easily maintained once all the optical elements are assembled in their predetermined positions.

Moreover, since hundreds, even thousands of the metal tubes each having the liquid-state precursor of the thermal cure adhesive in their small gaps can be heated in an oven at the same time, the manufacturing amount of the WDM device having the package structure of the present embodiment can be dramatically increased compared to that of the WDM device having the conventional package structure.

As a result, by having the package structure of the present invention, the amount of the adhesive leaking during the manufacturing process of a WDM device can be reduced and the yield of the manufacturing process can also be increased. In addition, since the relative position of each optical element is determined and maintained by the tubular fixing unit (a glass tube or a metal tube), the optical path (e.g. the collimation) is easily maintained once all the optical elements are assembled in their predetermined positions. The labor for carefully aligning all the optical elements involved can also be saved. Besides, the manufacturing process of the WDM device of the present invention can be greatly simplified and the manufacturing amount of the WDM device having the package structure of the present embodiment can be dramatically increased relative to that of the WDM device having the conventional package structure.

Although the present invention has been explained in relation to its preferred embodiment, it is to be understood that many other possible modifications and variations can be made without departing from the spirit and scope of the invention as hereinafter claimed.

What is claimed is:

1. A package structure for a wavelength division multiplexing device, comprising:
a tubular fixing unit having a low thermal expansion coefficient;
a first collimator partially embedded in the tubular fixing unit;
a second collimator partially embedded in the tubular fixing unit; and
a filter fitted inside the tubular fixing unit and located between the first collimator and the second collimator;
wherein the first collimator and the second collimator are fixed to the tubular fixing unit through an adhesive respectively.

2. The package structure as claimed in claim 1, wherein the first collimator is a GRIN lens.

3. The package structure as claimed in claim 1, wherein the second collimator is a GRIN lens.

4. The package structure as claimed in claim 1, wherein the adhesive is located between the tubular fixing unit and the embedded part of the first collimator.

5. The package structure as claimed in claim 1, wherein the adhesive is located between the tubular fixing unit and the embedded part of the second collimator.

6. The package structure as claimed in claim 1, wherein the tubular fixing unit is a glass tube.

7. The package structure as claimed in claim 6, wherein the adhesive is a UV cure adhesive.

8. The package structure as claimed in claim 1, wherein the tubular fixing unit is a metal tube.

9. The package structure as claimed in claim 8, wherein the adhesive is a thermal cure adhesive.

10. The package structure as claimed in claim 1, wherein the tubular fixing unit is a ceramic tube.

11. The package structure as claimed in claim 1, further comprising an external metal tube, wherein the external metal tube encompasses the tubular fixing unit.

12. The package structure as claimed in claim 11, further comprising two caps respectively mounted on the ends of the external metal tubes.

13. A package structure for a wavelength division multiplexing device, comprising:
a tubular fixing unit having a low thermal expansion coefficient;
a first collimator partially embedded in the tubular fixing unit, where an IR-cut coating is formed on the surface of the first collimator inside the tubular fixing unit; and
a second collimator partially embedded in the tubular fixing unit;
wherein the first collimator and the second collimator are fixed to the tubular fixing unit through an adhesive respectively.

14. The package structure as claimed in claim 13, wherein the first collimator is a GRIN lens.

15. The package structure as claimed in claim 13, wherein the second collimator is a GRIN lens.

16. The package structure as claimed in claim 13, wherein the adhesive is located between the tubular fixing unit and the embedded part of the first collimator.

17. The package structure as claimed in claim 13, wherein the adhesive is located between the tubular fixing unit and embedded the part of the second collimator.

18. The package structure as claimed in claim 13, wherein the tubular fixing unit is a glass tube.

19. The package structure as claimed in claim 18, wherein the adhesive is a UV cure adhesive.

20. The package structure as claimed in claim 1, wherein the tubular fixing unit is a metal tube.

21. The package structure as claimed in claim 8, wherein the adhesive is a thermal cure adhesive.

22. The package structure as claimed in claim 1, wherein the tubular fixing unit is a ceramic tube.

23. The package structure as claimed in claim 1, further comprising an external metal tube, wherein the external metal tube encompasses the tubular fixing unit.

24. The package structure as claimed in claim 11, further comprising two caps respectively mounted on the ends of the external metal tubes.
